(19) United States
(12) Patent Application Publication
(10) Pub. No.: US 2026/0288081 A1
(43) Pub. Date: Sep. 24, 2026

(54) EXTERIOR MEMBER, METHOD OF MANUFACTURING EXTERIOR MEMBER, AND ELECTRONIC DEVICE

(71) Applicant: CASIO COMPUTER CO., LTD., Tokyo (JP)

(72) Inventors: Kazuyuki TANABE, Tokyo (JP); Shin HITSUMOTO, Tokyo (JP)

(21) Appl. No.: 19/575,008

(22) Filed: Mar. 23, 2026

(30) Foreign Application Priority Data
Mar. 24, 2025 (JP) 2025-048293

(51) Int. Cl. G04G 17/08; G04B 37/22; G04G 21/02

(52) U.S. Cl. CPC G04G 17/08; G04B 37/225; G04G 21/025

(57) ABSTRACT

An exterior member includes a plate member and a resin member. The plate member includes a hole and an outer frame. The hole penetrates the plate member from the front surface to the back surface. The outer frame constitutes an outer circumferential side of the plate member. The resin member covers the front surface and the back surface of the plate member. The resin member is integrated with the plate member.

### CROSS-REFERENCE TO RELATED APPLICATIONS

This application is based upon and claims the benefit of priority from the prior Japanese Patent Applications No. 2025-048293, filed on Mar. 24, 2025, and No. 2025-187181, filed on Nov. 6, 2025, the entire contents of which are incorporated herein by reference.

### BACKGROUND OF THE INVENTION

### Technical Field

The present disclosure relates to an exterior member used for electronic devices, such as arm-wearable electronic devices and portable communication devices, a method of manufacturing the exterior member, and an electronic device equipped with the exterior member.

### Description of Related Art

Composite materials are conventionally used for exterior members of wristwatches, such as a bezel or a back cover. For example, Japanese patent No. 6,846,521 describes a structure in which a reinforced material having a three-dimensional honeycomb structure is covered with synthetic resin.

### SUMMARY OF THE INVENTION

According to the present disclosure, an exterior member includes: a plate member that includes a hole and an outer frame, the hole penetrating the plate member from a front surface to a back surface, the outer frame constituting an outer circumferential side of the plate member; and a resin member that covers the front surface and the back surface of the plate member and that is integrated with the plate member.

### BRIEF DESCRIPTION OF DRAWINGS

FIG. 1 is a front view of a wristwatch that is common among embodiments.

FIG. 2 is a side view of the wristwatch shown in FIG. 1.

FIG. 3 is a plan view of the back surface of a back cover of the wristwatch shown in FIG. 1.

FIG. 4 is an enlarged cross-sectional view along the A-A line in FIG. 3.

FIG. 5 is a plan view corresponding to FIG. 3, wherein a resin member is transparent.

FIG. 6 is a diagram indicating the position of a gasket in the plan view of FIG. 3, wherein the resin member is transparent.

FIG. 7A is a plan view of a plate member.

FIG. 7B is a cross-sectional view along the B-B line of FIG. 7A.

FIG. 8 is a cross-sectional view of main part of a metal mold for molding the back cover.

FIG. 9 is a cross-sectional view of main part of the metal mold in a modification.

FIG. 10 is a cross-sectional view of the back cover in a second embodiment.

### DETAILED DESCRIPTION

### First Embodiment

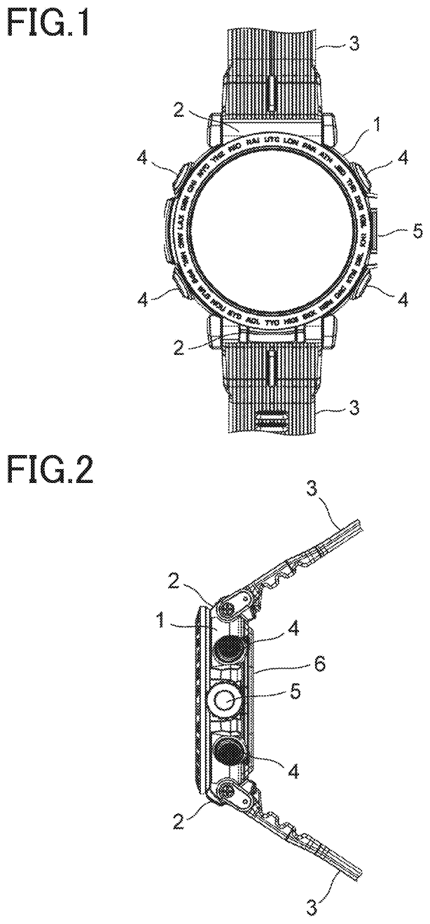

A first embodiment of the present disclosure is described with reference to the figures. FIG. 1 and FIG. 2 show a wristwatch (electronic device) to which the present disclosure is applied. The wristwatch includes a case 1. The case 1 includes band attachment parts 2 at 12 o'clock and 6 o'clock positions. To the band attachment parts 2, a wristband 3 is attached. On the outer edge of the case 1, push button switches 4 are provided at the positions of 2 o'clock, 3 o'clock, and 4 o'clock, respectively, and a crown 5 at the 3 o'clock position.

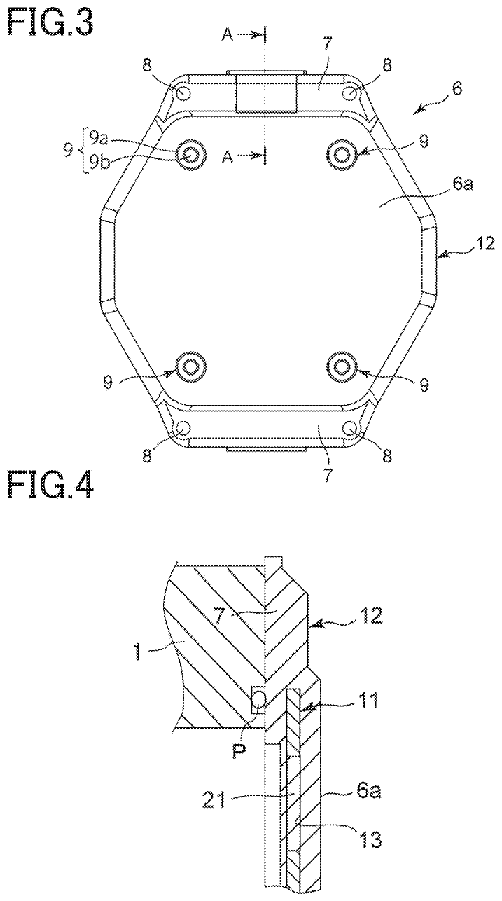

As shown in FIG. 2, a back cover 6 is attached to the back side of the wristwatch. FIG. 3 is a plan view showing only the back cover 6 at the back side. The back cover 6 has an octagonal external shape with rounded corners. At the 12 o'clock and 6 o'clock positions of the back cover 6, fixing parts 7 are formed to fix the back cover 6 to the wristwatch case 1. At the left and right corners of the fixing parts 7, screw holes 8 are formed for screwing the fixing parts 7 to the case 1. The main surface 6a on the back side of the back cover 6, excluding the peripheral part including the fixing parts 7, is substantially flat. The main surface 6a also has a substantially octagonal shape with rounded corners.

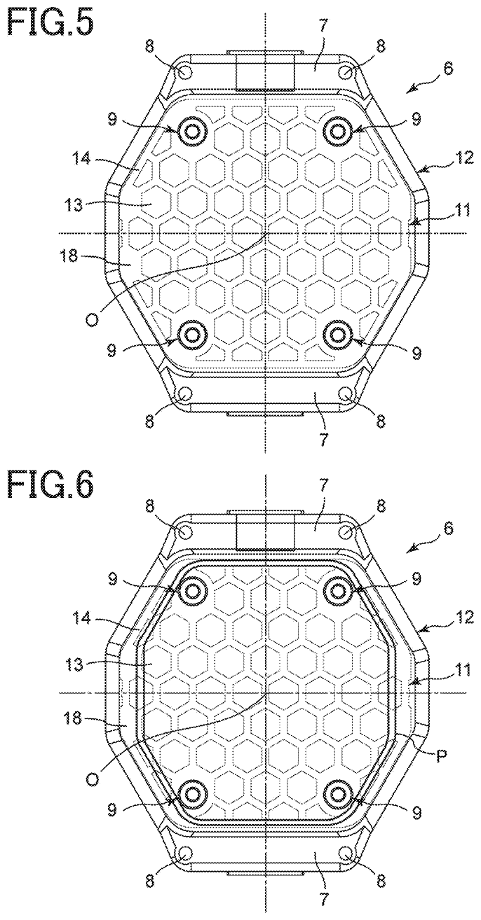

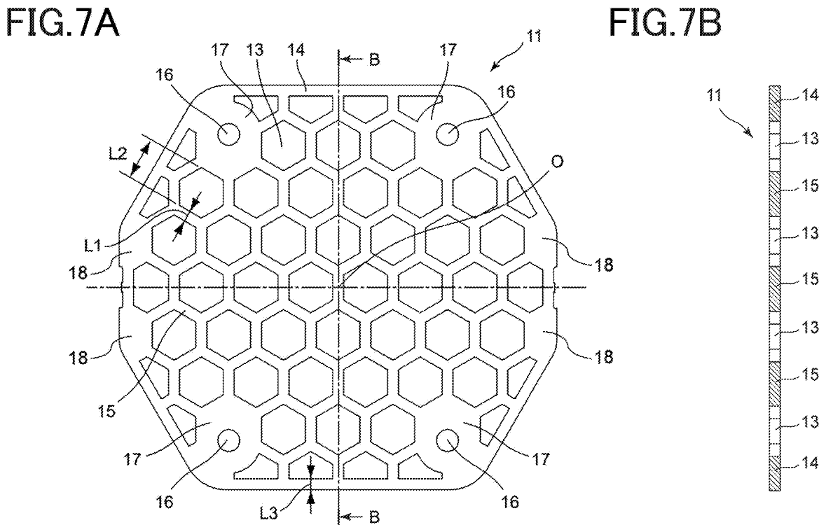

A plate member 11 is provided in the back cover 6 to be parallel to the main surface 6a, as shown in FIG. 4. The back cover 6 includes the plate member 11 and a resin member 12 that covers the front surface, the back surface, and the entire circumference of the plate member 11. The back cover 6 keeps the inside of the case 1 waterproof with a gasket P that is a ring-shaped waterproof member. The plate member 11 is made of stainless steel. The thickness of part of the back cover 6 corresponding to the main surface 6a is approximately 2.5 mm. The thickness of the plate member 11 is approximately 1 mm. FIG. 5 is a plan view corresponding to FIG. 3 and shows the positional relation between the main surface 6a of the back cover 6 and the plate member 11. FIG. 5 shows the case where the resin member 12 is made of a light-transmitting resin material and the plate member 11 is visible from the outside. As shown in FIG. 5, in the back cover 6, the position of the plate member 11 corresponds to the main surface 6a of the back cover 6 in plan view. The plate member 11 is positioned such that its center O in plan view approximately coincides with the center of the main surface 6a of the back cover 6. As shown in FIG. 6, in plan view, the most part of the gasket P as the ring-shaped waterproof member overlaps with an outer frame 14, a hole frame 15, a pressing part 17, and corner surfaces 18 of the plate member 11 (described later).

As shown in FIG. 3, the back cover 6 has blind holes 9 at positions near the corners of the main surface 6a and separate from the fixing parts 7. The blind holes 9 are formed in the process of forming the back cover 6. The blind holes 9 each have a tapered large-diameter part 9a that opens to the main surface 6a and a small-diameter part 9b that opens at the bottom center of the large-diameter part 9a. Thus, a step is formed inside the blind hole 9. The small-diameter part 9b is formed by a pin fitting hole 16 in the plate member 11 (described later). The small-diameter part 9b is closed with synthetic resin at the inner side of the back cover 6 (left side in FIG. 4).

Next, the plate member 11 is explained in detail with reference to FIG. 7. The external shape of the plate member 11 is a point-symmetric octagon with rounded corners, which is substantially the same as the shape of the main surface 6a at the back side of the back cover 6, as shown in FIG. 5. The plate member 11 includes multiple holes 13, the outer frame 14, and the hole frame 15. The holes 13 are through holes that pass through the front and back surfaces of the plate member 11. The holes 13 are formed side by side at regular intervals. The outer frame 14 constitutes the outer circumference of the plate member 11. The hole frame 15 is continuously formed around the holes 13. The hole frame 15 is formed to be continuous with the outer frame 14.

The holes 13 that cover nearly the entire area of the plate member 11 have a regular hexagonal shape, except the holes 13 at the periphery of the plate member 11 that are partially defined by the outer frame 14. The width of the hole frame 15 between adjacent holes 13, namely the distance between the adjacent holes 13, is uniform. Thus, the plate member 11 has a honeycomb structure constituted by the holes 13 and the hole frame 15. The width L1 of the hole frame 15 is approximately a quarter of the distance L2 between two parallel sides of the hole 13. The width L3 of the outer frame 14 constituting the outer circumference of the plate member 11 is equal to or substantially equal to the width of the hole frame 15.

The holes 13 are formed such that the hole frame 15 is located at the central part of the plate member 11, namely at the central part of the main surface 6a of the back cover 6. Further, the holes 13 are formed such that the holes 13 and the plate member 11 have a common symmetry axis in plan view. That is, as shown in FIG. 5 and FIG. 7A, the external shape of the plate member 11 is line-symmetric with respect to (i) a longitudinal center line passing through the center O and (ii) a transverse center line passing through the center O. Similarly, the holes 13 are formed to be line-symmetric with respect to the longitudinal center line and the transverse center line. That is, the holes 13 are formed to be point-symmetric with respect to the center O as the center of symmetry.

The plate member 11 has pin fitting holes 16. The pin fitting holes 16 each constitute the small-diameter part 9b of the blind hole 9, which opens to the back side of the back cover 6. The diameter of the pin fitting hole 16 is smaller than the hole 13. In each pin fitting hole 16, a positioning pin 57 (described later) is fitted when the back cover 6 is molded. Around each pin fitting hole 16, the pressing part 17 is formed. Each pressing part 17 is formed continuously between the outer frame 14 and the hole frame 15. The area of each pressing part 17 including the pin fitting hole 16 is substantially equal to the area of a hole 13 and part of the hole frame 15 constituting the circumference of the hole 13. At the corners of the octagonal plate member 11, the corner surfaces 18 are formed. The corner surfaces 18 do not have the hole 13. The area of the corner surface 18 is the total of (i) the area of a hole 13 corresponding to the corner surface 18 and (ii) the area of the outer frame 14 and the hole frame 15 defining the hole 13, when the holes 13 are assumed to be formed at the corner surfaces 18 in the same arrangement as the other holes 13. As shown in FIG. 4 and FIG. 6, the most part of the ring-shaped gasket P extends along and overlaps with the outer frame 14, the pressing parts 17, and the corner surfaces 18 of the plate member 11 in plan view. In particular, the pressing parts 17 and the corner surfaces 18 at the corners of the octagonal plate member 11 have a sufficiently wider area than the overlapping gasket P. When the back cover 6 is fastened to the case 1, the gasket P receives a pressing force from the outer frame 14, the pressing parts 17, and the corner surfaces 18 of the plate member 11, so that the gasket P is pressed stably. Thus, the waterproof property of the resin-based back cover, which is easily deformed, is improved. The ring-shaped gasket P may not overlap with all the outer frame 14, the pressing parts 17, and the corner surfaces 18 so as to extend along these parts 14, 17, and 18 in plan view. At least part of the point-symmetric positions of the gasket P (e.g., the pressing parts 17 at the 1 o'clock 7 o'clock directions) should overlap with the plate member 11 when the center of symmetry O is the approximate center of the plate member 11 in plan view.

According to the back cover 6, the front surface, the back surface, and the entire circumference of the plate member 11 are covered with the resin member 12. Further, the holes 13 are filled with the resin member 12. That is, the resin member 12 covering the entire plate member 11 has filling parts 21 that fill the respective holes 13 (see FIG. 4).

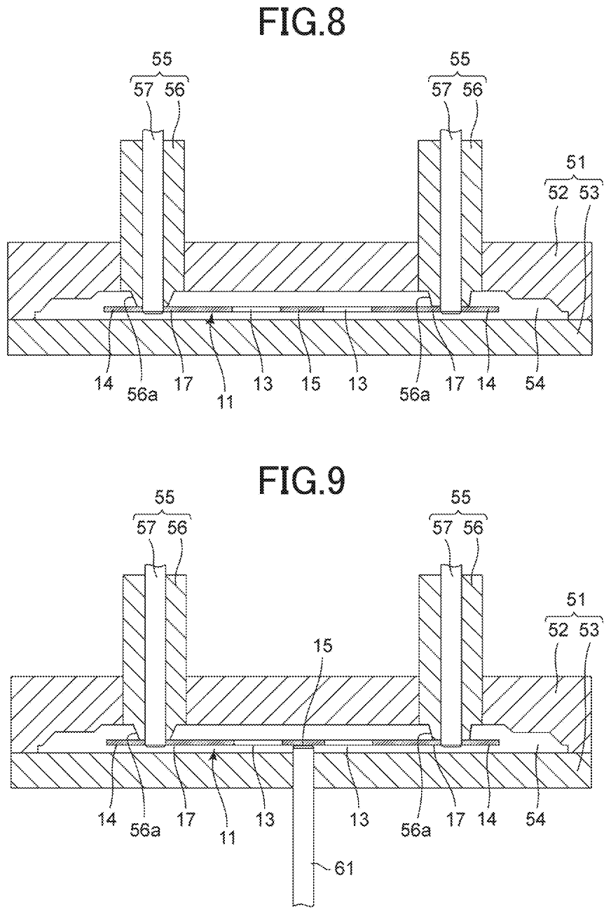

Next, the method of manufacturing the back cover 6 will be described. The back cover 6 is formed by first to third processes. In the first process, the holes 13 and the pin fitting holes 16 are formed in a plate material, namely a stainless steel plate, to form the plate member 11. In the second process, the plate member 11 is held at a fixed position in midair in a molding space (cavity) 54 by plate holders of paired metal molds 52 and 53 that are divided in the thickness direction of the plate member 11. The plate holders are provided to one of the paired metal molds 52 and 53 so as to project into the molding space 54 (see FIG. 8). In the third process, resin is injected into the molding space 54 to mold the resin member 12.

In the first process, the holes 13 and the pin fitting holes 16 are formed in a stainless steel plate by performing double-sided etching, for example, to form the plate member 11. To form the pressing parts 17 that stably press the gasket P, the pin fitting holes 16 are formed at positions near the outer frame 14 so that the pressing parts 17 are continuous with the outer frame 14.

In the second process, the metal mold 51 as shown in FIG. 9 is used. The metal mold 51 includes the upper metal mold 52 and the lower metal mold 53 that are divided in the thickness direction of the plate member 11. Inside the metal mold 51, the molding space 54 corresponding to the shape of the resin member 12 is formed. FIG. 8 corresponds to a cross-sectional view along a longitudinal virtual line that passes through the centers of the respective pin fitting holes 16 on the left side of FIG. 7A.

The upper metal mold 52 corresponds to one side of the resin member 12 that constitutes the back side of the back cover 6. The upper metal mold 52 has plate holders 55 that hold the plate member 11. The tips of the plate holders 55 project into the molding space 54 and correspond to the pin insertion holes 16 of the plate member 11. Each plate holder 55 has a stepped sleeve pin 56 and a positioning pin 57 fitted in the shaft center of the stepped sleeve pin 56. With the stepped sleeve pins 56 and the positioning pins 57, the plate holders 55 hold the plate member 11 at a fixed position in midair in the molding space 54 in a state where the plate member 11 is not in contact with the metal mold 51.

The tip part 56a of each stepped sleeve pin 56 has a tapered shape that corresponds to the large-diameter part 9a of the blind hole 9, which is formed at the back side of the back cover 6. The tip of the positioning pin 57 projects from the tip end of the stepped sleeve pin 56 by a length slightly greater than the thickness of the plate member 11. The tip of the positioning pin 57 is tapered. The positioning pins 57 are lightly press-fitted into the pin fitting holes 16 of the plate member 11 with a predetermined force and fasten the plate member 11 so that the plate member 11 does not escape from the positioning pins 57. Each positioning pin 57 is removable from the pin fitting hole 16 with a predetermined force.

With such plate holders 55, the plate member 11 is detachably fastened to the upper metal mold 52, and the plate member 11 is accurately positioned in midair in the molding space 54. That is, in the second process, the plate member 11 is fastened to the upper metal mold 52 by fitting the positioning pins 57 into the respective pin fitting holes 16 of the plate member 11. Further, the plate member 11 is held at a fixed position while being kept in midair in the molding space 54 by bringing the plate member 11 (the pressing parts 17) into contact with the tip ends of the stepped sleeve pins 56.

In the third process, the resin member 12 is molded by injecting resin into the molding space 54. The injected resin fills the holes 13 from the front and back sides of the plate member 11, so that the filling parts 21 of the resin member 12 are formed. Thus, the plate member 11 is firmly integrated with the resin member 12.

According to the honeycomb structure described in Japanese U.S. Pat. No. 6,846,521, for example, hexagonal cells are regularly arranged. When a reinforcing material having such a honeycomb structure is adopted to components having an arbitrary external shape (e.g., the back cover of a wristwatch), cells having the perfect shape cannot be formed on the outer circumference part of the reinforcing material. When the wristwatch receives an external shock, the stress is unevenly distributed, so that the back cover or other components may be deformed or damaged. Therefore, the structure of JP 6846521 cannot provide a sufficient level of shock absorbency.

On the other hand, the back cover 6 described above includes the plate member 11 and the resin member 12. The plate member 11 includes: the holes 13 that penetrate the plate member 11 from the front surface to the back surface; and the outer frame 14 that constitutes the outer circumference of the plate member 11. The resin member 12 covers the front and back surfaces of the plate member 11 and is integrated with the plate member 11. When the wristwatch 1 receives an external shock, the outer frame 14 of the plate member 11 disperses the shock. Thus, the plate member 11 provides a high level of shock absorbency. Since the stress against the shock does not concentrate locally on any part of the outer circumference of the plate member 11, the external shock can be efficiently dispersed and absorbed by the plate member 11. Thus, a higher level of shock absorbency is ensured.

In the back cover 6, the filling parts 21 of the resin member 12 fill the holes 13 of the plate member 11, so that the resin is bonded between the front side and the back side of the plate member 11. With the filling parts 21, the plate member 11 can be firmly fixed to the resin member 12. Further, since the resin member 12 covers the entire circumference of the plate member 11, the plate member 11 is more firmly fixed to the resin member 12 than when the resin member 12 covers only the front and back sides of the plate member 11.

In the plate member 11 of the back cover 6, the holes 13 are formed side by side. The hole frame 15 is continuously formed around each of the holes 13. Thus, the plate member 11 has a honeycomb structure. The hole frame 15 is continuous with the outer frame 14. According to such a structure, even though some of the holes 13 at the outer circumference part of the plate member 11 do not contribute to the honeycomb structure, the hole frame 15 that surrounds such holes 13 is continuous with the outer frame 14. Therefore, the stress is unlikely to concentrate on the corner parts of the outer circumference of the plate member 11 when the plate member 11 receives an external shock. With the plate member 11 having such a honeycomb structure, the back cover 6 is less likely to deform, or the resin member is less likely to be broken, by the external shock. Thus, the plate member 11 ensures a high level of shock absorbency and solidity of the back cover 6.

The holes 13 in the plate member 11 are formed such that the hole frame 15 is located at the central part of the plate member 11. When the plate member 11 receives an external shock, a large deformation force acts on the central part of the plate member 11 so as to bend the plate member 11. Since the hole frame 15 is located at the central part of the plate member 11, the hole frame 15 can efficiently disperse the deformation force toward the outer circumferential side of the plate member 11. Thus, flexure of the entire back cover 6 can be suppressed. Further, the holes 13 are formed such that the holes 13 and the plate member 11 have the same axis of symmetry in plan view. Thus, flexure of the entire back cover 6 can be further suppressed.

Herein, the holes 13 are formed in the plate member 11 such that the hole frame 15 is located at the central part of the plate member 11 as an example. For another example, the holes 13 may be formed to be rotationally symmetric with respect to the approximate center of the plate member 11 in plan view as the center of symmetry by adjusting the size of the holes 13. In such a case, the approximate center of the plate member 11 corresponds to one bifurcation point among multiple bifurcation points formed at multiple positions of the hole frame 15. The transverse center line of the hole frame 15 intersects the one bifurcation point. From the one bifurcation part, the hole frame 15 branches into three directions. In this case, the shock is distributed in three directions and efficiently dispersed toward the outer circumferential side of the plate member 11 by the hole frame 15. Thus, flexure of the entire back cover 6 can be suppressed.

Further, the gasket P that is a ring-shaped waterproof member is provided between the case 1 and the plate member 11. At least part of the point-symmetric positions of the gasket P overlaps with the plate member 11 in plan view, when the approximate center of the plate member 11 in plan view is the center of symmetry O. According to such a structure, the gasket P can be pressed stably. Thus, the waterproof property of the resin-made back cover, which is easily deformed, is improved.

In the second process in manufacturing the back cover 6, the plate member 11 is detachably fastened to the positioning pins 57 of the upper metal mold 52, so that the plate member 11 is positioned in the molding space 54. For another example, the following method may be adopted. As shown in FIG. 9, in addition to the plate holders 55 of the upper metal mold 52, a plate pressing part 61 that projects into the molding space 54 is provided to the lower metal mold 53 of the metal mold 51. The plate pressing part 61 is pressed against the plate member 11, so that the plate holders 55 and the plate pressing part 61 hold the plate member 11.

Specifically, the plate pressing part 61 is a cylindrical member similar to the positioning pins 57 of the plate holders 55, for example. The plate pressing part 61 is provided at a position between the plate holders 55 so as to correspond to the hole frame 15 of the plate member 11. In the second process, the plate pressing part 61 is pressed against the hole frame 15 of the plate member 11 being held at a fixed position by the plate holders 55. The plate pressing part 61 and the stepped sleeve pins 56 of the positioning pins 57 hold the plate member 11 therebetween. According to such a method, the plate member 11 can be securely held at a fixed position in the thickness direction even when the plate member 11 receives force by the injected resin, which is injected into the molding space 54 to mold the resin member 12 in the third process.

### Second Embodiment

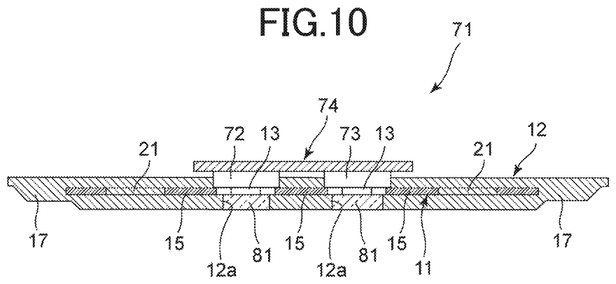

Next, a second embodiment of the present disclosure is described with reference to the figure. FIG. 10 is a cross-sectional view of a back cover 71 that is attached to the back side of the wristwatch, as in the first embodiment. The back cover 71 basically has the same structure as the back cover 6 in the first embodiment. The back cover 71 includes a sensor device 74 at the inner side (the upper side in FIG. 10). The sensor device 74 includes a light emitter 72 that irradiates a target (e.g., the skin of the user) with light and a light receiver 73 that receives light emitted by the light emitter 72 and reflected from the target. The sensor device 74 has a general configuration for measuring the pulse rate or other parameters of the user wearing the wristwatch.

In FIG. 10, the parts identical to the parts of the back cover 6 of the first embodiment are denoted by the same reference numerals, and the description thereof is omitted. Only the aspects of the back cover 71 different from the back cover 6 will be mainly explained. According to the back cover 71 of this embodiment, the resin member 12 is formed of a translucent resin material. The resin member 12 has two windows 12a at two positions at the approximate center of the back cover 71. The two windows 12a correspond to two adjacent holes 13 of the plate member 11. The two adjacent holes 13 are not filled with resin material. The windows 12a are closed by light-transmissive resin plates 81. On the inner surface of the back cover 71, the light emitter 72 and the light receiver 73 are provided at positions corresponding to the respective resin plates 81. The light emitter 72 and the light receiver 73 are connected to a sensor board 75. The light emitted by the light emitter 72 hits the arm of the user via one resin plate 81, and the reflected light is received by the light receiver 73 via the other resin plate 81.

In this configuration, the hole frame 15 is formed between the hole 13 corresponding to the light emitter 72 and the hole 13 corresponding to the light receiver 73. Therefore, part of the light emitted by the light emitter 72 that does not pass through the resin plate 81 but travels toward the light receiver 73 is blocked by the hole frame 15 while the pulse rate is measured, for example. The light receiver 73 mainly receives only the reflected light having passed through the resin plate 81 corresponding to the light receiver 73. Therefore, the pulse rate or other parameters can be accurately measured by the sensor device 74. That is, the hole frame 15 of the plate member 11 can suppress a decrease in accuracy of the sensor device (pulse rate sensor) as well as contributing to shock absorbency. Even when the resin member 12 is light-transmissive, the hole frame 15 functions as a light shield. Therefore, a decrease in the accuracy of the sensor device (pulse rate sensor) can be restrained.

In the embodiments, the present disclosure is applied to the back cover of a wristwatch. However, the present disclosure is not limited to this. The present disclosure is also applicable to an exterior member that constitutes electronic devices, such as wearable/arm-wearable devices (e.g., smartwatches) and portable communication devices, for example. The present disclosure is not limited thereto but includes the disclosure set forth in the claims and their equivalents.

1. An exterior member comprising:
a plate member that includes a hole and an outer frame, the hole penetrating the plate member from a front surface to a back surface, the outer frame constituting an outer circumferential side of the plate member; and
a resin member that covers the front surface and the back surface of the plate member and that is integrated with the plate member.

2. The exterior member according to claim 1, wherein the resin member includes a filling part that fills the hole.

3. The exterior member according to claim 2, wherein the resin member covers an entire circumference of the plate member including the filling part and the outer frame.

4. The exterior member according to claim 1, wherein:
the plate member includes multiple holes each of which is the hole formed side by side,
the plate member has a honeycomb structure in which a hole frame is continuously formed around each of the holes, and
the hole frame is continuous with the outer frame.

5. The exterior member according to claim 4, wherein the holes are arranged such that the hole frame is located at a central part of the plate member in plan view.

6. The exterior member according to claim 4, wherein the hole frame and the holes are arranged with respect to a center of the plate member in plan view as a center of symmetry.

7. The exterior member according to claim 4, wherein the hole frame and the holes are arranged such that a symmetry axis of the hole frame and the holes is identical to a symmetry axis of the plate member in plan view.

8. An electronic device comprising the exterior member according to claim 1.

9. An electronic device comprising the exterior member according to claim 2.

10. An electronic device comprising the exterior member according to claim 3.

11. An electronic device comprising the exterior member according to claim 4.

12. An electronic device comprising the exterior member according to claim 5.

13. An electronic device comprising the exterior member according to claim 6.

14. An electronic device comprising the exterior member according to claim 7.

15. The electronic device according to claim 8, further comprising a sensor that includes a light emitter that irradiates a target with light and a light receiver that receives reflected light from the target, wherein:
holes each of which is the hole are formed at two or more positions in the plate member,
the light emitter and the light receiver are provided at positions corresponding to different holes among the holes,
the light emitter irradiates the target with light via one of the different holes, and
the light receiver receives the reflected light from the target via another of the different holes.

16. The electronic device according to claim 8, further comprising:
a case; and
a ring-shaped waterproof member provided between the case and the plate member,
wherein in a case where a center of the plate member in plan view is a center of symmetry, at least part of point-symmetric positions of the waterproof member overlaps with the plate member in plan view.

17. A method of manufacturing an exterior member that includes:
a plate member that includes a hole and an outer frame, the hole penetrating the plate member from a front surface to a back surface, the outer frame constituting an outer circumferential side of the plate member; and
a resin member that covers the front surface and the back surface of the plate member and that is integrated with the plate member, the method comprising:
forming the plate member by making the hole in a plate-shaped material;
holding the plate member at a fixed position in a molding space in a state where the plate member is not in contact with paired metal molds by using a plate holder, the plate holder projecting into the molding space to hold the plate member and being provided to one of the paired metal molds divided in a thickness direction of the plate member; and
molding the resin member by injecting resin into the molding space.

18. The method of manufacturing the exterior member according to claim 17, wherein:
another of the paired metal molds is provided with a plate pressing part that projects into the molding space and that is to be pressed against the plate member, and
the plate member is held between the plate holder and the plate pressing part.
